(19) United States
(12) Patent Application Publication
(10) Pub. No.: US 2015/0029099 A1
(43) Pub. Date: Jan. 29, 2015

(54) METHOD FOR CONTROLLING TOUCH AND MOTION SENSING POINTING DEVICE

(71) Applicant: TIANJIN FUNAYUANCHUANG TECHNOLOGY CO., LTD., Tianjin (CN)

(72) Inventors: MING-YAO TSAI, HsinChu (TW); PO-SHENG SHIH, Hsinchu (TW); HO-CHIEN WU, New Taipei (TW)

(73) Assignee: TIANJIN FUNAYUANCHUANG TECHNOLOGY CO.,LTD., Tianjin (CN)

(21) Appl. No.: 14/242,870

(22) Filed: Apr. 2, 2014

(30) Foreign Application Priority Data
Jul. 26, 2013 (CN) 2013103187829

(51) Int. Cl. G06F 3/038

(52) U.S. Cl. CPC G06F 3/038
USPC 345/158

(57) ABSTRACT

A method for controlling a touch and motion sensing pointing device is disclosed. In the method, a touch on the pointing device is sensed through a touch sensing module. Whether or not a touch size of the touch is smaller than a predetermined size is determined when the touch is sensed. An output of coordinate signals of the pointing device is locked when the touch size of the touch is smaller than the predetermined size. Whether or not a persisting time of the touch is larger than a predetermined time is measured when the output of coordinate signals is locked. The output of coordinate signals is unlocked when the persisting time of the touch is greater than the predetermined time. A mouse-click signal is transmitted when the persisting time of the touch is smaller than or equal to the predetermined time.

### CROSS-REFERENCE TO RELATED APPLICATIONS

This application claims all benefits accruing under 35 U.S.C. §119 from China Patent Application No. 201310318782.9, filed on Jul. 26, 2013 in the China Intellectual Property Office, the content of which is hereby incorporated by reference.

1. Field

The present disclosure relates to methods for controlling pointers, and more specifically to a method for controlling a touch and motion sensing pointing device.

2. Background

Various programs developed for internet TV, projector, and game station use a display to show an operation screen and a handheld pointer, such as an “air mouse,” for remote operation and control. The air mouse is used to select the target object, such as an icon shown in the operation screen, and select the functions associated with the target object. The air mouse is handheld and operated in the air without placing on a surface of a desk. A motion detecting module in the air mouse detects the spatial motions to control a movement of a mouse cursor shown in the operation screen.

However, a subtle movement can cause a displacement of the mouse cursor in the operation screen. A mouse click action on the air mouse from pressing the button can cause movement of the air mouse, thereby causing the mouse cursor in the operation view to deviate from an original position. Thus, the accuracy for the air mouse to input a mouse click action is relatively low.

What is needed, therefore, is to provide a method for controlling a pointing device to accurately execute a mouse click action.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present embodiments.

FIG. 1 is a block diagram of one embodiment of a pointing device.

FIG. 2 is a flowchart of an embodiment of a control method for the pointing device.

FIG. 3 is a flowchart of another embodiment of the control method for the pointing device.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

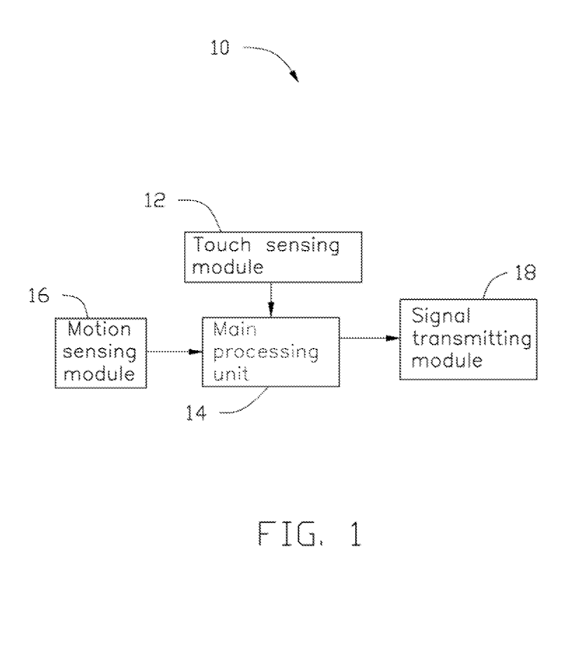

Referring to FIG. 1, an embodiment of a touch and motion sensing pointing device 10 includes a touch sensing module 12, a main processing unit 14, a motion sensing module 16, and a signal transmitting module 18. The pointing device 10 is configured for moving a mouse cursor shown on a display screen according to a spatial motion of the pointing device 10, and controlling the mouse cursor to execute a mouse-click operation according to a touch on a surface of the pointing device 10. The touch sensing module 12 is configured for sensing touches on the surface of the pointing device 10 and sending touch signals to the main processing unit 14. The motion sensing module 16 is configured for sensing its own spatial displacements and sending motion signals to the main processing unit 14. The main processing unit 14 is configured for receiving, analyzing, processing the touch signals and the motion signals. The signal transmitting module is configured for transmitting recognizable signals for a display device displaying mouse cursor coordinates and a mouse-click operation. More specifically, the signal transmitting module transmits coordinate signals corresponding to the motion signals and transmits mouse-click signals corresponding to the touch signals. The display device can have the mouse cursor coordinates based on the coordinate signals and have the mouse-click operations based on the touch signals.

The touch sensing module 12 can be a touch panel, a touch pad, or a conductive button. The main processing unit 14 can be a central processing unit (CPU) or a micro control unit (MCU). The motion sensing module 16 can include an acceleration sensor or an angular velocity sensor, such as a gyroscope. The signal transmitting module can include an infrared transmission module, a BLUETOOTH® module, or a WiFi module. The display device can be a computer display, a smart television, or a game station. The touch sensing module 12, motion sensing module 16, main processing unit 14, and signal transmitting module can be stored in a shell of the pointing device 10. A touch sensing surface of the touch sensing module 12 can be exposed from the case.

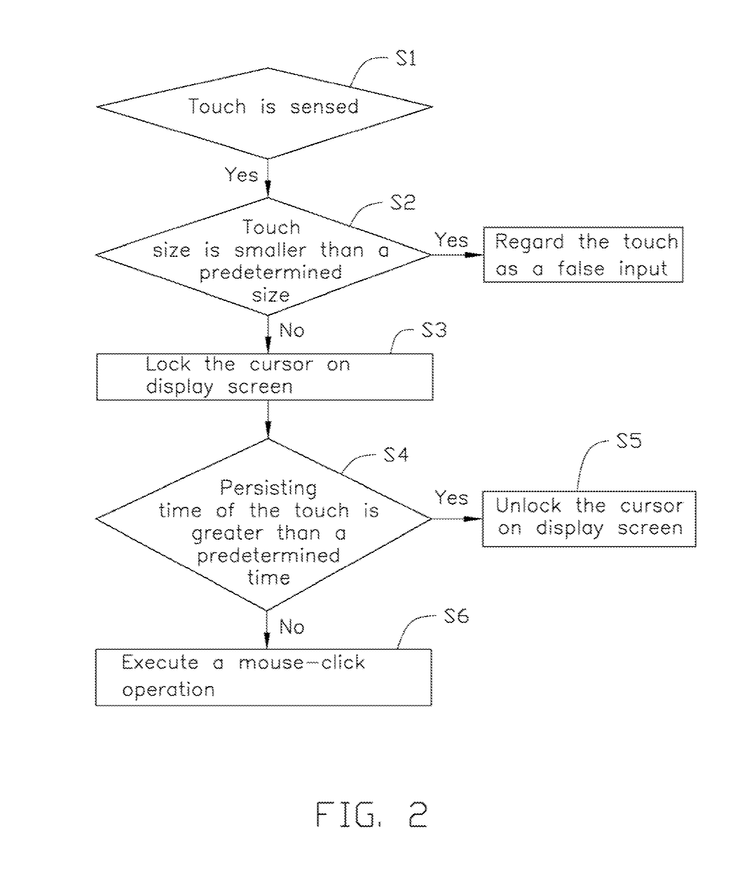

Referring to FIG. 2, one embodiment of a method for controlling the touch and motion sensing pointing device 10 includes steps of:

S1, sensing a touch on the pointing device 10 through the touch sensing module 12;

S2, determining if a touch size of the touch is smaller than a predetermined size when the touch is sensed;

S3, locking an output of coordinate signals of the pointing device 10 when the touch size of the touch is smaller than the predetermined size;

S4, measuring if a persisting time of the touch is greater than a predetermined time when the output of coordinate signals is locked;

S5, unlocking the output of coordinate signals when the persisting time of the touch is greater than the predetermined time; and

S6, transmitting a mouse-click signal when the persisting time of the touch is less than or equal to the predetermined time.

In one embodiment, the predetermined size is 1 square inch; the predetermined time is in a range from 0.2 seconds to 0.4 seconds.

In the present disclosure, the term “touch size” is a contact size between a touch object and the surface of the touch sensing module 12. The touch object can be a finger or a touch pen. In the present disclosure, the term “persisting time” is a time period from the time the touch object contacts the surface of the touch sensing module 12 to the time the touch object leaves from the surface of the touch sensing module 12.

In one embodiment, when the finger touches the touch sensing module 12, the touch sensing module 12 senses a capacitance change or a resistivity change induced by the touch and sends corresponding touch signals to the main processing unit 14. The main processing unit 14 analyzes and processes the touch signals to achieve the touch coordinate and touch size. In another embodiment, the pointing device 10 further includes a touch signal processing unit (e.g., an integrated circuit (IC)), which processes the touch signals to achieve the touch coordinate and touch size and output the touch coordinate and touch size to the main processing unit 14. Further, the persisting time of the touch can be recorded by the touch signal processing unit or the main processing unit 14.

In one embodiment, the motion sensing module 16 detecting a spatial motion of the pointing device 10 and sends corresponding motion signals to the main processing unit 14. The motion signals represent displacements of the motion sensing module 16 on at least two perpendicular directions in the space. The main processing unit 14 analyzes and processes the motion signals to calculate the coordinates of the mouse cursor. In another embodiment, the pointing device 10 further includes a motion signal processing unit (e.g., another integrated circuit (IC)), which processes the motion signals to achieve the coordinates of the mouse cursor and output the coordinates of the mouse cursor to the main processing unit 14.

The output of coordinate signals can be originally unlocked. That is, the signal transmitting module is continuously transmitting the coordinates of the mouse cursor to the display device before step S3. The display receives the coordinates of the mouse cursor and can simultaneously show a cursor move on the screen according to the coordinates. When the output of coordinate signals is locked in step S3, whenever the pointing device 10 moves, the coordinates are no longer transmitted until the output is unlocked. The cursor shown on the display screen cannot move during the signal locking period.

In the step S2, the main processing unit 14 or the touch signal processing unit compares the touch size with the predetermined size. When the main processing unit 14 or the touch signal processing unit determines that the touch size is smaller than the predetermined size, the steps S3 and S4 are processed. When the main processing unit 14 or the touch signal processing unit determines that the touch size is larger than or equal to the predetermined size, the locking step is not processed, and the main processing unit 14 allows the signal transmitting module to transmit the coordinate signals of the pointing device 10. The method can further include a step of transmitting the coordinate signals of the pointing device 10 to the display device when the touch size is larger than or equal to the predetermined size. From this step, if the touch size is larger than the predetermined size, the touch is regarded as a false input that may be caused by grabbing the pointing device 10 with a hand, and not an intentional touch of the finger.

In the step S3, the main processing unit 14 stops the signal transmitting module from transmitting the coordinate signals of the pointing device 10 to lock the output of the coordinate signals.

In the step S4, the main processing unit 14 or the touch signal processing unit compares the persisting time of the touch with the predetermined time.

In the step S5, when the main processing unit 14 or the touch signal processing unit determines that the persisting time of the touch is greater than the predetermined time, the main processing unit 14 allows the signal transmitting module to transmit the current coordinate signals of the pointing device 10. The cursor shown on the display screen continuously moves according to the coordinate signals.

In the step S6, when the main processing unit 14 or the touch signal processing unit determines that the persisting time of the touch is less than or equal to the predetermined time, the main processing unit 14 allows the signal transmitting module to transmit a mouse-click signal to the display device. A mouse-click operation is executed on the position where the cursor is locked.

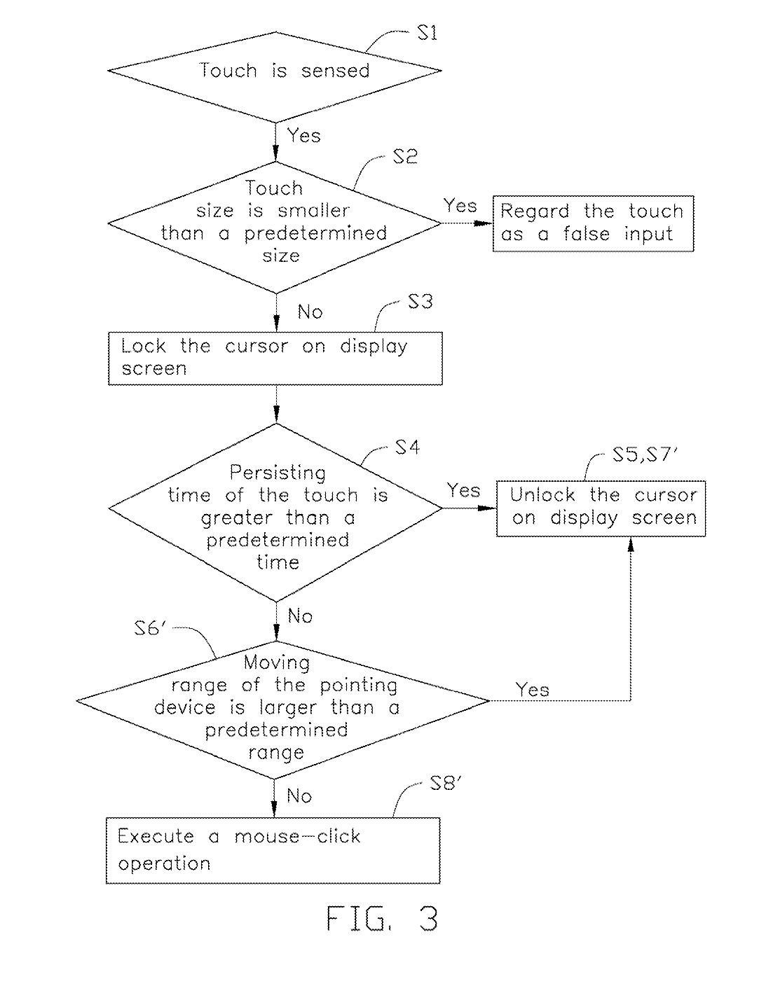

Referring to FIG. 3, another embodiment of the method for controlling the touch and motion sensing pointing device 10 includes steps S1 to S5 of the embodiment of FIG. 2 in addition to the following:

S6′, examining if a moving range of the pointing device 10 is larger than a predetermined range;

S7′, unlocking the output of coordinate signals when the moving range of the pointing device 10 is larger than a predetermined range; and

S8′, transmitting a mouse-click signal when the moving range of the pointing device 10 is smaller than or equal to the predetermined range.

The predetermined range can be in a range from about 500 to ppi/seconds to about 1000 ppi/seconds. The unit “ppi/second” represents the number of pixels per unit second. The moving range represents the movement distance per unit time of the pointing device 10. The motion sensing module 16 can further sense the moving range, and the main processing unit 14 can analyze the motion signals per unit time sent from the motion sensing module 16 and the result of the moving range of the pointing device 10.

In the step S6′, the main processing unit 14 compares the moving range with the predetermined range.

In the step S7′, when the main processing unit 14 determines that the moving range is larger than the predetermined range, the main processing unit 14 allows the signal transmitting module to transmit the current coordinate signals of the pointing device 10. The cursor shown on the display screen continuously moves according to the coordinate signals.

In the step S8′, when the main processing unit 14 determines that the moving range is smaller than or equal to the predetermined range, the main processing unit 14 allows the signal transmitting module to transmit a mouse-click signal to the display. A mouse-click operation is executed on the position where the cursor is locked.

In this embodiment, the steps S4 and S6′ can be processed one by one or at the same time. The output of the coordinate signals can be unlocked either when the persisting time of the touch is greater than the predetermined time or when the moving range of the pointing device 10 is larger than the predetermined range. The mouse-click signal can be transmitted to the display to execute the mouse-click operation when both the persisting time of the touch is less than or equal to the predetermined time and the moving range of the pointing device 10 is less than or equal to the predetermined range

In use, the user waves the pointing device 10 in air, and the display screen simultaneously shows the cursor moving with the pointing device 10. When the cursor moves to a target position, and the mouse-click operation is to be executed, the user touches the touch sensing module 12 (e.g., touch pad) on the pointing device 10. However, in air, there is no support for the pointing device 10. Thus, the pointing device 10 may have subtle movement due to the touch thereby affecting the position of the cursor on the display screen. At this time, the position of the cursor on the display screen is first locked, and the user sees if the position of cursor is still at the target position. If so, the user releases the touch in time (i.e., the touch does not persist longer than the predetermined time), and the mouse-click operation is executed. If not, the user keeps touching the touch sensing module 12 for a longer time (i.e., the touch exceeds the predetermined time), and the mouse-click operation is canceled. Further, the moving range of the pointing device 10 can be used as another criterion to decide the execution of the mouse-click operation.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for controlling a touch and motion sensing pointing device comprising a touch sensing module, a main processing unit, a motion sensing module, and a signal transmitting module, the method comprising steps of:
sensing a touch through the touch sensing module;
determining if a touch size of the touch is smaller than a predetermined size when the touch is sensed;
locking an output of coordinate signals of the touch and motion sensing pointing device when the touch size of the touch is smaller than the predetermined size;
measuring if a persisting time of the touch is greater than a predetermined time when the output of coordinate signals is locked;
unlocking the output of coordinate signals when the persisting time of the touch is greater than the predetermined time; and
transmitting a mouse-click signal when the persisting time of the touch is smaller than or equal to the predetermined time.

2. The method of claim 1, wherein the predetermined size is about 1 square inch.

3. The method of claim 1, wherein the predetermined time is in a range from 0.2 seconds to 0.4 seconds.

4. The method of claim 1, wherein the transmitting the mouse-click signal and the output of the coordinate signals are processed by the signal transmitting module.

5. The method of claim 1 further comprising sensing a motion of the touch and motion sensing pointing device through the motion sensing module, and the output of the coordinate signals corresponds to the motion of the touch and motion sensing pointing device.

6. The method of claim 1, wherein the motion sensing module detects a spatial motion of the touch and motion sensing pointing device and sends motion signals to the main processing unit, and the main processing unit analyzes and processes the motion signals to calculate coordinates of a mouse cursor.

7. The method of claim 1, wherein the touch and motion sensing pointing device further comprises a motion signal processing unit, the motion sensing module detects a spatial motion of the touch and motion sensing pointing device and sends motion signals to the motion signal processing unit, and the motion signal processing unit processes the motion signals to achieve coordinates of a mouse cursor and sends the coordinates of the mouse cursor to the main processing unit.

8. The method of claim 1, wherein the main processing unit or the touch signal processing unit compares the touch size with the predetermined size.

9. The method of claim 1 further comprising transmitting coordinate signals of the touch and motion sensing pointing device when the touch size is larger than or equal to the predetermined size.

10. The method of claim 1, wherein the main processing unit or the touch signal processing unit compares the persisting time of the touch with the predetermined time.

11. A method for controlling a touch and motion sensing pointing device comprising a touch sensing module, a main processing unit, a motion sensing module, and a signal transmitting module, the method comprising steps of:
sensing a touch through the touch sensing module;
determining if a touch size of the touch is smaller than a predetermined size when the touch is sensed;
locking an output of coordinate signals of the touch and motion sensing pointing device when the touch size of the touch is smaller than the predetermined size;
measuring if a persisting time of the touch is greater than a predetermined time when the output of coordinate signals is locked;
unlocking the output of coordinate signals when the persisting time of the touch is greater than the predetermined time; and
examining if a moving range of the pointing device is greater than a predetermined range;
unlocking the output of coordinate signals when the moving range of the pointing device is greater than a predetermined range; and
transmitting a mouse-click signal when the moving range of the pointing device is smaller than or equal to the predetermined range.

12. The method of claim 11, wherein the predetermined range is in a range from about 500 ppi/seconds to about 1000 ppi/seconds.

13. The method of claim 11, wherein the main processing unit compares the moving range with the predetermined range.

14. The method of claim 11, wherein the measuring and the examining are processed simultaneously.
